(19) United States
(12) Patent Application Publication
(10) Pub. No.: US 2026/0076290 A1
(43) Pub. Date: Mar. 19, 2026

(54) Method for Determining a Distribution of Fertilizer Grains

(71) Applicant: Amazonen-Werke H. Dreyer SE & Co. KG, Hasbergen-Gaste (DE)

(72) Inventors: Justus DREYER, Osnabrück (DE); André GROßE BRINKHAUS, Münster (DE); Per Christian HEISEL, Osnabrück (DE); Arnd KIELHORN, Osnabrück (DE); Florian RAHE, Lotte (DE); Markus STRÖBEL-FRÖSCHLE, Georgsmarienhütte (DE)

(73) Assignee: Amazonen-Werke H. Dreyer SE & Co. KG, Hasbergen-Gaste (DE)

(21) Appl. No.: 19/108,805

(22) PCT Filed: Jul. 20, 2023
(86) PCT No.: PCT/EP2023/070130

§ 371 Date: Mar. 5, 2025

(30) Foreign Application Priority Data
Sep. 15, 2022 (DE) 10 2022 123 597.1

(51) Int. Cl. A01C 17/00

(52) U.S. Cl. CPC A01C 17/008

(57) ABSTRACT

A method for determining a distribution of fertilizer grains comprising the steps of laying out at least two collecting devices for fertilizer grains at predetermined positions, spreading the fertilizer grains over the at least two collecting devices using a fertilizer spreader and capturing the distribution of the fertilizer grains on the at least two collecting devices.

### CROSS REFERENCE TO RELATED APPLICATIONS

The present application claims priority under 35 U.S. C. § 365 to PCT/EP2023/070130 filed on Jul. 20, 2023 and under 35 U.S.C. § 119(a) to German Application No. 10 2022 123 597.1 filed on Sep. 15, 2022, both of which are incorporate by reference in their entireties.

### TECHNICAL FIELD

The invention relates to a method and a system for determining the distribution of fertilizer grains.

### BACKGROUND

When spreading fertilizer grains, the spreading pattern of a fertilizer spreader (hereinafter also referred to as “spreading pattern”) depends on the flow behavior and flight behavior of the fertilizer grains. These depend, among other things, on the grain size, grain shape, true density, bulk density, grain strength, moisture, coefficient of friction and surface properties of the grains. In principle, there are recommended settings for different fertilizer spreaders, in particular different centrifugal discs, which can be retrieved from databases or read from so-called spreading tables, taking into account the respective fertilizer type. However, deviations in fertilizer quality, changes in the inclination of the spreader, spreading mechanism and/or centrifugal disc(s), wind, moisture of the fertilizer, changes in quantity and/or segregation of the grain size fractions, may result in deviations from the expected spreading pattern. Consequently, the actual distribution of the fertilizer, in particular with regard to the transverse distribution, must be checked in practical use.

For this purpose, it is known, for example from EP 2 923 546 B1, to use an adhesive mat/plate to catch and hold fertilizer grains that have been spread, to spread fertilizer grains over this mat/plate and to determine the distribution of fertilizer grains that have arrived on the adhesive mat/plate. Thus, the distribution of the fertilizer grains can be determined at the location of the adhesive mat/plate.

### SUMMARY

One of the objects of the disclosure is to provide an improved method for determining a distribution of fertilizer grains and an improved system for doing so.

The method for determining a distribution of fertilizer grains comprises the steps of laying out at least two collecting devices for fertilizer grains at predetermined positions, spreading the fertilizer grains over the at least two collecting devices using a fertilizer spreader, which may be, in particular, a centrifugal fertilizer spreader, and capturing the distribution of the fertilizer grains on the at least two collecting devices. The method also comprises the step of determining the distribution of fertilizer grains on the at least two collecting devices and optionally a step of interpolating the distribution of fertilizer grains for at least one region of the spreading pattern of the fertilizer spreader.

A collecting device may in particular comprise or be an adhesive mat/plate as described in EP 2 923 546 B1. Alternatively, a collecting device may comprise or be, for example, a measuring tray as describe d in DE 10 2004 017 075 A1, other measuring trays or other devices that are suitable for holding fertilizer grains at or near the point of impact, for bringing them to rest or for collecting them. A combination of different collecting devices, for example one or more measuring trays and one or more adhesive mats, may also be used.

The collecting devices are laid out at predetermined positions, for example at certain positions in a field, e.g. in relation to a track or the edge of the field, or at predetermined positions in relation to a stationary fertilizer spreader. “Predetermined positions” are typically positions that are already known before the collecting devices are laid out. In other words, the collecting devices are not typically laid out arbitrarily, but at predetermined positions. The collecting devices may therefore be laid out in a predetermined pattern. Such laying out may be done by hand or by machine or in another suitable manner.

The fertilizer grains are spread by a fertilizer spreader, e.g. a centrifugal fertilizer spreader or a pneumatic fertilizer spreader. This fertilizer spreader may be a centrifugal spreader. It may comprise at least one, typically two, centrifugal discs, whereby the centrifugal disc(s) may be driven in rotation. Alternatively, the fertilizer spreader may be a pneumatic spreader that uses at least one pneumatic conveyor line with one or more associated baffle plates to spread fertilizer pneumatically. The fertilizer spreader may further comprise a storage container and a metering unit. Typically, the fertilizer grains are introduced via the metering unit to the spreading mechanism, e.g. onto a centrifugal disc or into the pneumatic system. For example, the fertilizer spreader may comprise a metering unit for each centrifugal disc or for each pneumatic conveyor line, via which the fertilizer grains (the fertilizer) can be applied in adjustable quantities to the centrifugal disc or in the pneumatic conveyor line. In the case of a pneumatic fertilizer spreader, the metering unit may be a section of a metering drum, for example.

For example, the fertilizer spreader may comprise two centrifugal discs arranged side by side transversely to the intended direction of travel, each centrifugal disc comprising one, two or more throwing vanes adjustable in their effective length and/or angle. A fertilizer grain feeding system may be associated with each centrifugal disc, which is configured to feed the fertilizer grains to a point on the centrifugal disc (feeding point). The feeding point may be adjustable concentrically (in particular along a constant distance from the center of the centrifugal disc) and/or radially (in particular along a straight line through the center of the centrifugal disc with an adjustable distance from the center of the centrifugal disc) on a centrifugal disc. By adjusting one or more fertilizer spreader parameters, in particular, for example, the vane position and/or the effective length of the throwing vanes on the centrifugal discs, the mounting height of the centrifugal spreader, the diameter of the centrifugal disc(s), the inclination of the centrifugal spreader, the inclination of the spreading mechanism, the inclination of the centrifugal disc(s), the speed of the centrifugal discs, the disc selection and/or the feeding point of the fertilizer grains on the centrifugal disc, the spreading pattern of the fertilizer spreader may be influenced.

When spreading the fertilizer grains over the at least two collecting devices, the fertilizer grains are distributed by the fertilizer spreader in such a way that it is to be expected that some of them will land on at least one of the at least two collecting devices. This may be the case, for example, when driving through the track, for example, if the collecting devices are laid out in such a way that they are located in the region to be covered with fertilizer grains when driving through a track. In other embodiments, the spreading of the fertilizer grains over the at least two collecting devices may take place when the fertilizer spreader is stationary or when the fertilizer spreader is moving in a direction other than the direction of travel along the track. For example, the fertilizer spreader may be swung over the at least two collecting devices, in particular rotated about a point (pivot point of the fertilizer spreader), wherein the at least two collecting devices may be arranged, for example, in a straight line, in particular on a line through the pivot point of the fertilizer spreader radially, i.e. at different distances from the pivot point of the fertilizer spreader.

Subsequently, the distribution of the fertilizer grains on the at least two collecting devices is captured by means of an imaging device, e.g. a (digital) camera. In this case, for example, (digital) images of the at least two collecting devices for fertilizer grains may be generated, e.g. in at least two (digital) camera images.

Subsequently, the distribution of fertilizer grains on the at least two collecting devices is determined, e.g. calculated. The recordings, e.g. (digital) camera images, may each be processed, for example, to calculate an image of the spread fertilizer grains on the respective collecting device and optionally calculate a distribution of the fertilizer grains, e.g. a quantity of fertilizer grains and/or density, in particular on the respective collecting device, or otherwise determine the distribution of the fertilizer grains by means of image analysis. When calculating an image of the fertilizer grains spread on the respective collecting device, the image may be calculated in such a way that it comprises only fertilizer grains and no longer any other structures.

In particular, by determining the distribution of the fertilizer grains, especially if the area of the collecting device is known (which is typically the case), various properties (density, specific locations, grain sizes, grain size distribution and/or grain number) of the fertilizer grains on the surface on the respective collecting device can be determined. The density of the fertilizer grains, for example, may indicate whether the required amount of fertilizer is present per unit area. The specific locations of the fertilizer grains may allow conclusions as to whether the measurement comprises errors. If the specific locations are very unevenly distributed, e.g. all located in the direction of an edge, this may indicate that the grains have rolled, e.g. due to an inclined collecting device. In this case, the determined distribution may not be reliable. In particular, the edge of the collecting device may be excluded from the evaluation. If the fertilizer grains then accumulate at the edge, there may be an insufficient quantity or a reduced quantity of fertilizer grains in the evaluation area compared to the actual quantity, which reduces the quality of the measurement. The method may comprise issuing a warning due to insufficient quality of the determined distribution.

For example, each of the collecting devices may be imaged individually using a (digital) camera and an image of the fertilizer grains spread on the respective collecting device may be generated from each individual (digital) camera image. In particular, an image may represent the distribution of the individual fertilizer grains on the collecting device. In particular, such an image may be used to determine the distribution of the fertilizer grains on the respective collecting device.

Subsequently, an interpolation step of the distribution of fertilizer grains may optionally be carried out for at least one region of the fertilizer spreader's spreading pattern. In addition to the determined distribution of the individual fertilizer grains on the at least two collecting devices, the optional interpolation step may optionally also take into account one or more items of information or assumptions about the spreading pattern. For example, interpolation may be carried out on the assumption that the fertilizer spreader's spreading pattern is kidney-shaped and/or axially symmetrical, that the fertilizer quantity decreases linearly or according to a known function from the center of the spreading pattern outwards, and/or that it comprises a certain (optionally selectable or set) working width. Alternatively or additionally, the interpolation may be carried out with the assumption that the spreading pattern is demand-adjusted, i.e. in particular that it applies a target quantity, which may in particular be location-dependent, and/or that the spreading pattern is designed for supplementation by an overlapping connecting track, i.e. in particular that, with a single pass, a spreading pattern results with such properties that a constant or demand-adjusted fertilizer quantity results from two, three or more passes in adjacent tracks.

In particular, the step of interpolating the distribution of fertilizer grains may comprise interpolating the distribution of fertilizer grains for at least one region of the spreading pattern of the fertilizer spreader, e.g. one half of an axisymmetric spreading pattern or the like. The at least one region of the fertilizer spreader's spreading pattern for which the distribution of fertilizer grains can optionally be interpolated can, for example, be located between the at least two collecting devices. It can be larger than the region covered by the at least two collecting devices, e.g. if one or more items of information or assumptions about the spreading pattern are taken into account. In particular, it may comprise part of the fertilizer spreader's spreading pattern, e.g. one half, one third, an edge area, the central area or the entire fertilizer spreader's spreading pattern. For example, if the distribution of fertilizer grains has been determined on two collecting devices, one located in the center of the spreading pattern and one located at the edge of the spreading pattern, the distribution of the fertilizer grains may be interpolated as a uniform distribution of the fertilizer grains between these two known distributions, or as a linear or other (known) function between these two distributions, and thus, for example, extrapolated to the entire spreading pattern of the fertilizer spreader. In particular, one or more items of information or assumptions about the spreading pattern may be taken into account. Alternatively or additionally, distributions other than linear distributions of the fertilizer grains between two known distributions may be used for the interpolation. Accordingly, if the distribution of fertilizer grains has been determined on three or more collecting devices, the distribution of the fertilizer grains may be interpolated as a, in particular continuous, distribution of the fertilizer grains between these three or more known distributions, in particular, for example, as a linear or other (known) function between these three or more distributions, and thus, for example, the entire spreading pattern of the fertilizer spreader may be inferred.

By determining the distribution of the fertilizer grains on the at least two collecting devices, it may in particular be possible to determine one or more properties of the (entire) spreading pattern, e.g. the spreading fan, in particular important characteristics of the (entire) spreading pattern, in particular the spreading fan. For example, assuming a certain shape and/or size, in particular width, of the (entire) spreading pattern, in particular spreading fan, and/or a certain distribution of the fertilizer grains within an (entire) spreading pattern, in particular spreading fan, the position and/or size of the (entire) spreading pattern, in particular spreading fan, and/or the fertilizer grain density in the (entire) spreading pattern, in particular spreading fan, and/or the fertilizer grain density in the (entire) spreading pattern, in particular spreading fan, may be determined. Optionally, a resulting fertilizer distribution on the field may be determined using an interpolated spreading pattern of the fertilizer spreader and the information about the overlap of adjacent tracks.

The imaging device may be, in particular, a digital camera, for example a camera of a mobile device, e.g. a cell phone camera or the camera of a tablet.

According to the disclosure, the predetermined positions may be specified, in particular be determined, based on the expected spreading pattern.

In particular, the predetermined positions may be calculated in view of the expected spreading pattern (which may optionally already be set on the fertilizer control) or may be calculated after entering the desired spreading pattern. The expected spreading pattern may be specified or known, in particular, by specifying one or more fertilizer spreader parameters, e.g. spreading parameters or setting parameters, such as spreading width, spreading angle, position of the feeding system, disc speed and/or the working width to be maintained in the track system, and/or environmental parameters, e.g. inclination of the ground. The expected spreading pattern may be dependent on an expected spreading situation, e.g. based on whether it is an inner field, which headland is used, whether the field comprises boundaries, whether there are bodies of water in the vicinity, whether there are obstacles in the field or similar, and may be preset or retrievable based on one, two or more of the aforementioned parameters. Alternatively, the predetermined positions may also be specified for an expected spreading pattern in a database or other information, for example a manual or spreading tables (and thus determined from these).

When determining the predetermined positions based on the expected spreading pattern, determining a number of collecting devices with which an entire spreading pattern can be interpolated with the necessary accuracy may in particular be comprised. Furthermore, determining the predetermined positions based on the expected spreading pattern may comprise determining predetermined positions, in particular for the number of collecting devices, with which the entire spreading pattern can be interpolated with the necessary accuracy, taking into account one or more pieces of information or assumptions about the spreading pattern.

The predetermined positions may, for example, be arranged only along part of the expected spreading pattern. In particular, in the case of a symmetrical (expected) spreading pattern, the predetermined positions may be arranged along only one side (half) of the spreading pattern. This can be advantageous because fewer collecting devices are then required than if the collecting devices are arranged along the entire spreading pattern in order to obtain comparable information and/or increased accuracy can be achieved with the same number of collecting devices if the collecting devices present are (intelligently) distributed only along part of the expected spreading pattern.

At least one of the predetermined positions, e.g. at least two or all of the predetermined positions, may be arranged in a region of interest. In particular, a region of interest may comprise only part of the spreading pattern, e.g. one half or one third of the spreading pattern, or be arranged in only part of the spreading pattern, e.g. one half or one third of the spreading pattern. For example, a region of interest may be arranged along a straight line, in particular along a straight line perpendicular to the direction of travel of the fertilizer spreader. A region of interest may, for example, be located in a region in which a greater deviation from normal spreading is expected in the interior of the field, for example in an expected edge, e.g. in the spreading flank or at a spreading boundary or in the region of the spreading boundary, in the headland and/or in the vicinity of a body of water, it also being possible for regions beyond the spreading boundary to be comprised in the region of interest. Alternatively or additionally, a region of interest may be located in an expected maximum of the expected spreading pattern.

In some embodiments, a predetermined position may be located, for example, beyond the expected spreading pattern, in order to check whether spreading does in fact not extend beyond the expected spreading pattern, and/or in the region of the spreading boundary or spreading flank of the expected spreading pattern, in order to check whether the expected spreading pattern corresponds to the actual spreading pattern.

For example, in particular if there are more than two collecting devices, the predetermined positions may be arranged in a region of interest with a higher density than in other regions. In a further embodiment, the predetermined positions may be arranged only in the region of interest, so that only the part of the spreading pattern in the region of interest can be inferred from the captured distribution.

An exemplary region of interest may, for example, be the boundary region of the spreading pattern or the flank of the spreading pattern. If the predetermined positions are located in a region of interest with a higher density than in other regions, it is possible to determine more precisely how the distribution of fertilizer grains behaves there. In particular, the interpolation of the spreading pattern can then be more accurate in the region of interest than in other regions of the spreading pattern.

Alternatively, the at least two collecting devices can all be laid out at predetermined positions with the same density, for example at equal distances from one another.

The individual collecting devices may be included equally in a calculation of the spreading pattern. Alternatively, collecting devices that are laid out at predetermined positions, for example, with the same density, may be included in the interpolation of the spreading pattern with a certain weighting. For example, the distribution of fertilizer grains on one or more collecting devices in a region of interest may be weighted more heavily than the distribution of fertilizer grains on one or more other collecting devices when interpolating the spreading pattern.

The predetermined positions may be determined with respect to the fertilizer spreader, to a planned stop position for the fertilizer spreader, at which the fertilizer spreader is stopped for determining the distribution of the fertilizer grains, or to a (planned) track of the fertilizer spreader. The predetermined positions may also be specified or determined with respect to the field. In particular, for example, to check switch points, e.g. to switch off one or more parts of the fertilizer spreader (e.g. for wedge spreading or boundary spreading) or the switch-on and switch-off points of the fertilizer spreader, or the switch points between the inside of the field and the headland, e.g. to switch off one half or the entire fertilizer spreader, it may be advantageous to placing the collecting devices at certain positions in the field.

For example, the collecting devices may be arranged in different configurations at predetermined positions (for at least two collecting devices) concentrically on an arc around the fertilizer spreader and/or in a kidney shape or parabola arc within a circle sector or circle segment around the fertilizer spreader and/or radially to the fertilizer spreader at different distances.

Determining the predetermined position in relation to the fertilizer spreader may be particularly advantageous when the fertilizer grains are being spread if the fertilizer spreader does not move relative to or move towards the collecting devices, e.g. only rotates, i.e. in particular when the fertilizer spreader is spreading while stationary.

By determining the predetermined positions in relation to the fertilizer spreader, information about the spreading width and/or spreading angle and/or spreading width distribution and/or spreading angle distribution can be captured from the distribution of the fertilizer grains. In particular, if the fertilizer spreader performs one or no relative movement with respect to the collecting devices, a configuration of the predetermined positions at different radial distances may allow determining the spreading width and/or spreading width distribution from the distribution of the fertilizer grains. In particular, if the fertilizer spreader does not move relative to the collecting devices, a configuration of the predetermined positions on an arc around the fertilizer spreader may allow the distribution of the fertilizer grains to be used to determine the spreading angle and/or the spreading angle distribution. The spreading angle may correspond to the fertilizer spreader's discharge angle, i.e. the angle between an axis parallel to the designated direction of travel of the centrifugal spreader (in the longitudinal direction of the centrifugal spreader) through the pivot point of an associated centrifugal disc of a centrifugal spreader and the axis through the pivot point of the associated centrifugal disc of a centrifugal spreader and the intersection of the radial and concentric 50% percentile. The scatter angle distribution may correspond to the variance of the scatter angle given above.

In other embodiments, the fertilizer grains may be spread using a fertilizer spreader while it moves relative to the predetermined positions of the collecting devices, for example along a track. For example, it may be necessary to travel only along one track. This may be used, for example, to determine a distribution of fertilizer grains with predetermined positions on one side of the track (e.g. when a symmetrical spreading pattern is expected) or on both sides of the track, with which a region of the spreading pattern of the fertilizer spreader, in particular the entire spreading pattern of the fertilizer spreader, may be determined.

In other embodiments, two, three or more adjacent tracks are driven on while spreading the fertilizer, so that a resulting distribution of fertilizer grains in a field can be determined based on the collecting devices at the predetermined positions. In particular, driving over two or three adjacent tracks may be advantageous if the tracks are driven over so that the spreading patterns overlap. Thus, for determining the distribution of the fertilizer grains on the field, in particular the distribution of the fertilizer grains transverse to the direction of travel (transverse distribution), it is not necessary to calculate the distribution of the fertilizer grains on the field, e.g. from an interpolation of the spreading pattern at the locations of the collecting devices with optional subsequent assumption of a superimposition of two or more spreading patterns. Rather, the distribution of the fertilizer grains on the collecting devices may show the actually resulting distribution, in particular the transverse distribution, of the fertilizer grains on the field in the region of the collecting devices under actual conditions.

The predetermined positions may, for example, be calculated (for the respective method to be carried out for determining a distribution of fertilizer grains). The calculation of the predetermined positions may be carried out, for example, on an (external) server to which the data can be transmitted, for example, by radio transmission or similar, or on a mobile device (for example, a cell phone or tablet) or the on-board computer. The calculation may comprise determining the number of collecting devices required to interpolate an entire spreading pattern with the necessary accuracy and calculating the predetermined positions. The calculated predetermined positions, and optionally also the number of collecting devices, may then be transmitted, for example to a mobile device or the on-board computer, so that the collecting devices may be laid out at the predetermined positions.

In particular, one, two or more of the following parameters may be used to calculate the predetermined positions: a GPS position, in particular the GPS position of the field and/or the lane to be driven on, the position of the sun, the degree of cloud cover, which may be determined in particular by measuring the light conditions, e.g. using an optical sensor or camera and/or weather information, e.g. through online services or a local weather station, the time, one or more inputs, fertilizer spreader parameters and/or fertilizer type.

The GPS position may be determined, for example, by a mobile device or the on-board computer. The position of the sun may be determined by a shadow cast, for example, in an image of the surroundings by a camera, for example, in a mobile device, by means of GPS, and/or based on the time and/or the direction of view when measuring or direction of travel over selected tracks and/or using information from the Internet or otherwise. For example, the position of the sun can be determined from a combination of the GPS position, the direction of view at the time of measurement or the direction of travel, and the time. The degree of cloud cover, for example, can be retrieved from a server (from the Internet) or entered manually. One or more inputs may comprise, for example, manual inputs or inputs that are read or captured, for example, by the on-board computer and entered (manually or automatically). One or more inputs may, for example, comprise the purpose of the measurement and/or the expected or intended spreading situation, such as a check of the spreading pattern, a check of certain aspects of the spreading pattern (e.g. spreading flank, boundary spreading), a check of the switch-on and switch-off points, or a planned readjustment of the fertilizer spreader setting. Alternatively or additionally, inputs may comprise environmental parameters, such as wind strength, slope of the terrain, humidity or other parameters of the on-board computer. Fertilizer spreader parameters may comprise, for example, setting parameters or discharge parameters, the type of device, and/or similar. The type of fertilizer is particularly relevant for the flight behavior of the fertilizer grains. It may therefore be advantageous to take this into account when calculating the predetermined positions.

Alternatively, the predetermined positions relative to the track, the field or the fertilizer spreader may be located already before the method for determining a distribution of fertilizer grains at fixed predetermined positions, which may be based in particular on the expected and/or intended spreading situation. For example, these may be looked up in tables, reference works or a database or (automatically) read out. Such predetermined positions may be specified in the reference works, for example, based on the type of fertilizer spreader and/or the desired spreading pattern.

The predetermined positions (whether calculated or read out) can be output, for example, via a mobile device (e.g. tablet, cell phone) or the on-board computer, and used to lay out the collecting devices. For example, this output may be provided as GPS data for laying out the collecting devices and/or as a display on a map of the field. Optionally, a mobile device may be configured to support a user in laying out the collecting devices, for example by emitting a signal indicating where a collecting device should be laid out. In particular, a mobile device, e.g. a cell phone with an app, may be used to provide correction or directional information as to the direction in which an existing collecting device is to be laid out or a collecting device already in place is to be moved. Alternatively or additionally, an image of the field with a marked target position may be displayed as an augmented reality of the collecting device, for example by a mobile device, so that the collecting device to be applied can be brought into line with the target position. Alternatively, the on-board computer or a mobile device may be configured to control where the collecting devices are applied mechanically, e.g. by an attachment to the fertilizer spreader. Optionally, before or while capturing the distribution of the fertilizer grains on the at least two collecting devices, it may be checked by an imaging device, in particular, for example, with the help of GPS, whether the respective collecting device is arranged in the correct predetermined position. If there is a deviation from the correct predetermined position, a warning may optionally be issued, in particular regarding a reduced quality of the determined distribution.

Using the determined distribution of the fertilizer grains, one (or more) parameters of the spreading process may be determined.

The one parameter of the spreading process, in particular for the fertilizer spreader with the respective disc or baffle plate used, which may be determined using the distribution of the fertilizer grains, may be or comprise: spreading width, spreading width distribution, spreading flank, spreading boundary, spreading direction, spreading height, spreading angle, switch points of the fertilizer spreader, e.g. switch points for switching off one or more parts of the fertilizer spreader (e.g. for wedge spreading or boundary spreading) or switch points for switching the fertilizer spreader on and off, or switch points between the interior of the field and the headland, e.g. a half-sided or complete shutdown of the fertilizer spreader, deviation from the expected spreading pattern, deviation from the expected transverse distribution, 3D spreading pattern, 2D spreading pattern, spreading quantity, density of the fertilizer grains spread, grain size distribution.

When determining the spreading width, in particular, an average spreading width and the variance of this (spreading width distribution) may be determined, optionally based on the angle at which spreading is carried out. For example, the 50th or 95th percentile (the width within which 50% or 95% of all fertilizer grains land) may be determined for the spreading width. When determining the spreading flank, it may be determined, for example, how quickly the fertilizer quantity in the lateral area of the spreading pattern drops, in particular in the transverse distribution, and/or whether the fertilizer quantity in the lateral area of the spreading pattern reduces evenly.

When determining the spreading boundary, the throwing width for boundary spreading may be determined, e.g. the 50th or 95th percentile of the throwing width for the boundary spreading range, from a spreading flank for boundary spreading, for example.

When determining the spreading direction, the (main) spreading direction may be determined, for example, at which the maximum spreading quantity of each spreading disc or each baffle plate is achieved and around which the spreading pattern is arranged and/or which divides the spreading pattern in such a way that 50% of the fertilizer grains spread end up on each side of it. The spreading height may be determined using the distribution of fertilizer grains, if, for example, further information such as spreading speed or similar is known. When determining a deviation from the expected spreading pattern, it may be determined in particular whether the distribution of fertilizer grains corresponds to the distribution of fertilizer grains that would have been achieved with the expected spreading pattern.

For example, a 3D spreading pattern may describe the two-dimensional spreading pattern when the fertilizer spreader is stationary and then the respective amount of fertilizer as the third dimension, e.g. a kidney-shaped spreading pattern with the amount of fertilizer encoded, in particular by color or height. A 2D spreading pattern may correspond to the transverse distribution of the fertilizer grains (in a direction perpendicular to the direction of travel of the fertilizer spreader). This transverse distribution may, for example, be the total resulting transverse distribution from one or more passes in adjacent tracks, or the transverse distribution resulting from a pass to the right or left of the fertilizer spreader (to which both centrifugal discs or all baffle plates contribute), or the resulting transverse distribution from a pass to the right or left of the fertilizer spreader, to which only one centrifugal disc contributes.

Several of the aforementioned parameters of the spreading process may also be determined.

In addition to the distribution of the fertilizer grains on the at least two collecting devices, one or more additional pieces of information may be used to determine the one or more parameters of the spreading process.

For example, the one or more additional pieces of information may comprise: the result of a radar measurement (for example, a radar measurement on the fertilizer spreader that can be used to determine the (main) spreading direction and/or the spreading fan, e.g. shape, height and/or width and/or spreading angle, where the discharge angle may be determined in particular from a radar measurement of quantity per angle and/or the spreading width may be determined by a Doppler measurement), corresponding previous measurements, for example comparative measurements from a spreading hall, previous measurements with the fertilizer spreader, fertilizer spreader type, set and/or measured operating parameters of the fertilizer spreader, such as disc diameter, throwing vane configuration, speed, metered quantity and/or travel speed, and/or properties of the fertilizer, for example grain size, grain size, flight characteristics, weight and/or shaking tests. In particular, one or more of these data may already be stored or deposited for use, e.g. in the on-board computer or a mobile device or centrally, e.g. in an app. In particular, the current working parameters of the fertilizer spreader, which are needed anyway for the use of a fertilizer spreader, may be used as additional information.

The fertilizer spreader type may in particular comprise operating parameters of the fertilizer spreader. Information about the spreader type and/or the centrifugal disc used may be stored or indicated on a database or in a reference book (e.g. spreading table). The set and/or measured operating parameters of the fertilizer spreader may be, for example, the amount of fertilizer grains applied per unit of time (determined, for example, based on multiple weighing of the remaining fertilizer, e.g. by one or more scales attached to the fertilizer container, or based on the measured mass flow, in particular via radar measurements and/or torque), the current working width and/or the appearance of an intended spreading pattern (e.g. spreading kidney, transverse distribution). The set working parameters of the fertilizer spreader, in particular their starting values, may be known, for example, from the distribution along the transverse direction from the spreading hall or a spreading hall image by rotating the fertilizer spreader.

For example, if a distribution of the fertilizer grains across the track has been determined and the spreading direction is known (e.g. from a radar measurement), the spreading width of the spreading pattern can be determined. Conversely, the spreading direction of the spreading pattern can be determined from the distribution of the fertilizer grains across the track and a known spreading width (e.g. from radar measurements).

In other embodiments, only the distribution of fertilizer grains is used to determine one or more parameters of the spreading process.

After determining the parameters of the spreading process, one or more nominal settings for the fertilizer spreader can be generated (recalculated) based on the determined parameters of the spreading process. The actual setting or settings (when determining the parameters of the spreading process) may also be included in the generating (calculation). These one or more nominal settings may be generated, for example, by an on-board computer, a mobile device such as a cell phone or tablet, or externally, for example on a server. The newly calculated nominal settings for the fertilizer spreader can then be set on the fertilizer spreader, e.g. manually or automatically.

For example, nominal settings may be generated for one or more fertilizer spreader parameters, in particular setting parameters such as the position of the throwing vanes on the centrifugal discs, the mounting height of the centrifugal spreader, the inclination of the centrifugal spreader, the speed of the centrifugal discs and/or the feeding point of the fertilizer grains on the centrifugal disc. For example, if the captured distribution of the fertilizer grains shows that an actual value does not correspond to the nominal value, for example for the spreading flank, the boundary spreading setting, the spreading width, the spreading width distribution and/or the spreading angle, the nominal value is recalculated and one or more nominal settings for the fertilizer spreader are generated (and then set on the fertilizer spreader).

Optionally, fertilizer grains may be distributed again over the at least two collecting devices and the distribution of the fertilizer grains on the at least two collecting devices may be captured to check whether the generated nominal settings have improved the spreading pattern.

The disclosure further comprises a system for determining a distribution of fertilizer grains, in particular a determining of a distribution of fertilizer grains as described above, which comprises two collecting devices for fertilizer grains that can be laid out at different positions, as well as means for capturing the distribution of fertilizer grains on the at least two collecting devices. The means for capturing the distribution of the fertilizer grains on the at least two collecting devices may comprise, in particular, an imaging device and optionally a processor configured to capture the distribution of the fertilizer grains from an (digital) image. The means for capturing the distribution of the fertilizer grains may in particular comprise a mobile device, such as a smartphone or tablet with a (digital) camera, wherein the mobile device may comprise a processor that may comprise a program configured to capture the distribution of the fertilizer grains.

The system may be configured to perform the steps respectively related to the method described above. In particular, the system may comprise a processor and a storage medium, the storage medium comprising machine-readable instructions that, when configured and executed by the processor, determine a distribution of fertilizer grains on the at least two collecting devices and optionally perform further steps as described above.

### BRIEF DESCRIPTION OF THE DRAWINGS

Aspects of the disclosure are apparent from the accompanying figures, which are not to scale. The same reference signs are used for the same objects in the various figures.

FIG. 1a shows a plan view of a possible configuration of the collecting devices at predetermined positions,

FIG. 1b shows a plan view of a possible configuration of the collecting devices at predetermined positions,

FIG. 2 is a plan view of a possible configuration of the predetermined positions

FIG. 3 is a flow chart of an exemplary method.

### DETAILED DESCRIPTION

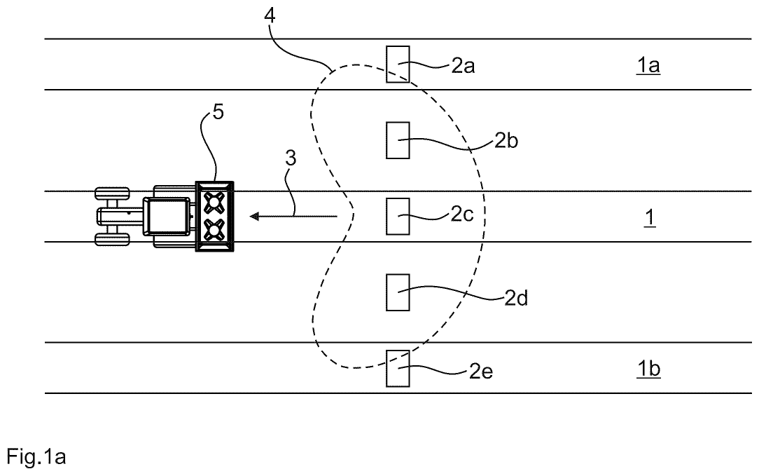

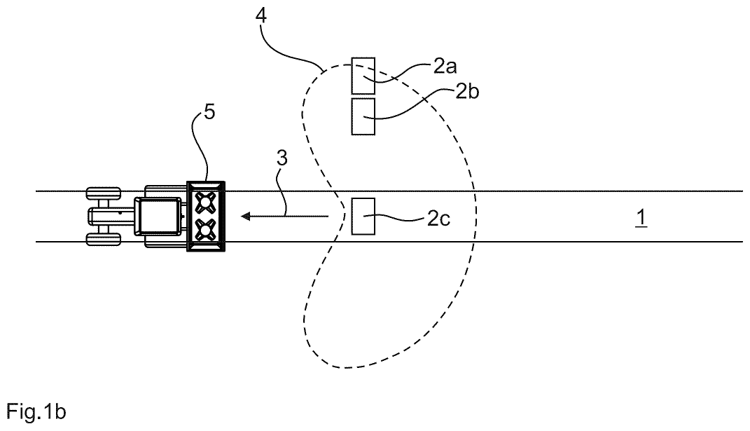

FIG. 1a shows a plan view of a possible configuration of collecting devices at predetermined positions in relation to a track 1, with five collecting devices 2a, 2b, 2c, 2d, 2e arranged as an example at the predetermined positions. The size of the collecting devices is not to scale: the collecting devices may be significantly smaller than shown in the diagram, in particular in com-parison to the spreading pattern.

In other embodiments, there may be more or fewer than five predetermined positions and corresponding collecting devices. The configuration of the predetermined positions is shown here as an example, transverse to the direction of travel 3 along the track 1. In other embodiments, the predetermined positions may be arranged differently.

The expected spreading pattern 4, which would be approximately expected if the fertilizer spreader 5 would spread without moving with regard to the track, is shown as a spreading fan.

When the fertilizer spreader 5 moves along the track 1, the resulting distribution of fertilizer grains corresponds to a smooth superimposition of the corresponding 3D spreading patterns (integral of the 3D spreading patterns in the direction of travel), which, in this example, when only track 1 is driven, may have a trapezoidal shape. In this context, a trapezoidal shape may be particularly indicative of the fact that the transverse distribution (perpendicular to track 1) of the fertilizer, i.e. the density of the fertilizer perpendicular to the track, in the region around the track (in the center of the track and an outward region), comprises a (substantially) constant value and, from two points (symmetrical to one another with respect to track 1) falls off towards the edge, in particular (essentially) linearly, to 0, wherein typically the two regions in which the distribution decreases are axisymmetrical with respect to one another with respect to track 1. Thus, a homogeneous distribution of the fertilizer grains in the field may be obtained by suitable superimposition of the spreading patterns from adjacent tracks. A suitable superimposition of the spreading patterns from adjacent tracks may in particular comprise that two spreading patterns from adjacent tracks are superimposed in such a way that the one trapezoidal distribution falls off to 0 where the constant value is reached in the adjacent trapezoidal distribution, so that the trapezoidal (transverse) distributions overlap to form a homogeneous (transverse) distribution.

Optionally, in a method for determining a distribution of fertilizer grains, in addition to driving on track 1, the adjacent tracks, track 1a and track 1b, may also be driven on with the fertilizer spreader 5, typically in the opposite direction. In this case, the distribution of fertilizer grains on the collecting trays roughly corresponds to the resulting distribution of fertilizer grains in the field.

When the fertilizer spreader 5 is stationary in the track 1, the distribution of fertilizer grains corresponds to the distribution of fertilizer grains in the spreading pattern at the point where the predetermined positions are located.

In FIG. 1a, the predetermined positions with collecting devices 2a-2e are arranged equidistantly along the entire width of the expected spreading pattern (and also somewhat beyond it).

The fertilizer grains may be spread with relative movement of the fertilizer spreader to the collecting devices or when the fertilizer spreader is stationary to the collecting devices.

Using the determined actual distribution of the fertilizer grains, with knowledge of the pre-determined positions at which the collecting devices 2a-2e are arranged, and optionally an assumption about the target distribution of the fertilizer grains, a parameter of the spreading process may be determined, e.g. in this case the deviation of the measured distribution from the expected distribution of the expected spreading pattern (also referred to as “the deviation from the expected spreading pattern”).

FIG. 1b shows a configuration of the predetermined positions with three collecting devices 2a, 2b, 2c as an example along only part, in particular half (the right half in the direction of travel 3, which is in particular drawn in the figure as the upper half), of the expected spreading pattern 4. In the example shown, the collecting devices 2a-2c are not arranged in the same density, but are arranged in a region of interest, here the region of the spreading flank, with a higher density (smaller distances between them).

The spreading of the fertilizer grains may be carried out as described for FIG. 1a (wherein tracks 1a, 1b optionally to be driven down are not shown in FIG. 1b), as may the optional determining of a parameter of the spreading process.

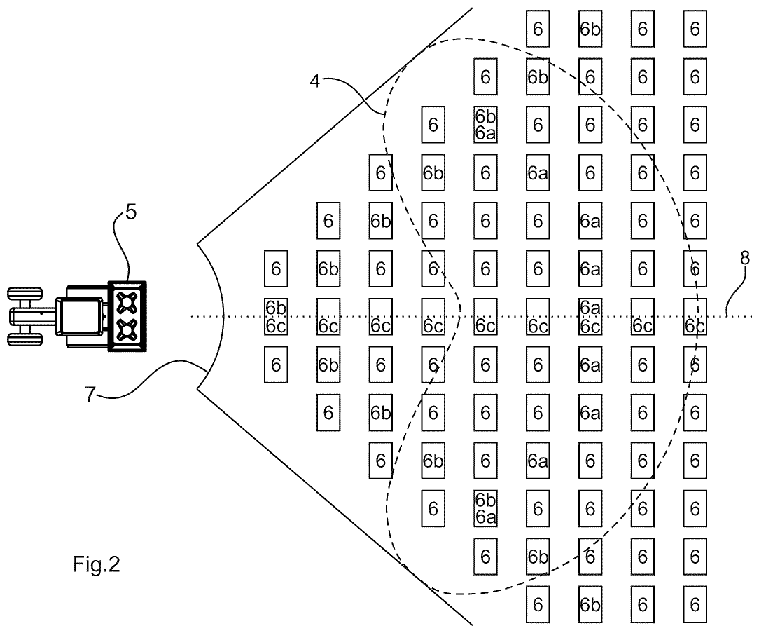

FIG. 2 shows a top view of a possible configuration of collecting devices at predetermined positions 6 (comprising also 6a, 6b, 6c), wherein the predetermined positions 6 in FIG. 2 are particularly suitable for determining a distribution of fertilizer grains when the fertilizer spreader 5 does not perform any relative movement with respect to the predetermined positions 6. Alternatively or additionally, the predetermined positions 6c from FIG. 2 may allow the switch points of the fertilizer spreader and/or the distribution in the headland to be checked. The positions 6c may be arranged, as shown, in particular along a straight line in the direction of travel 8.

The predetermined positions 6 are arranged here, for example, in a flat configuration within a circular sector 7. In the example shown, they are arranged with the same density. In other embodiments, they may be arranged with different densities, e.g. in a region of interest, e.g. in the region of the spreading flank, e.g. in the right or left third of the spreading pattern (in FIG. 2, this corresponds to the upper third or lower third), with a higher density (not shown).

When configured around a stationary fertilizer spreader 5, the predetermined positions may be arranged radially, in particular, from less than the expected spreading width to beyond the expected spreading width, for example, equidistantly. A corresponding arrangement may be seen, for example, at the predetermined positions 6b and/or 6c along imaginary straight lines. This may be used to check the expected spreading width of the fertilizer spreader 5 and optionally also to capture the fluctuation in the spreading width.

With the configuration of the predetermined positions 6 determined in FIG. 2, one or more parameters of the spreading process can be determined, in particular using the distribution of the fertilizer grains, in particular the (main) spreading direction and/or the spreading width and/or the spreading angle. Optionally, one or more nominal settings, e.g. for the fertilizer spreader, can then also be generated. For example, nominal settings may be generated that are intended to change the spreading direction and/or the spreading width and/or the spreading angle.

In other embodiments, the predetermined positions 6 may also be arranged in a different pattern, e.g. within a segment of a circle, along a line radially from the fertilizer spreader 5, or along an arc around the fertilizer spreader 5 (not shown).

A configuration of the predetermined positions 6c along a line radially from the fertilizer spreader 5 may allow determining the spreading width and/or spreading width distribution of the fertilizer spreader 5, in particular when stationary. One configuration of the predetermined positions 6b may be in particular along the main spreading direction, which may be known or determined by another measurement, e.g. radar measurement. Thus, the configuration of the predetermined positions 6b may allow determining the spreading width and/or spreading width distribution of the fertilizer spreader 5 along the main spreading direction, in particular when stationary.

A configuration of the predetermined position 6a along a segment of an arc around the fertilizer spreader may be used to determine the (real) spreading direction of the fertilizer spreader, in particular when stationary.

When the fertilizer spreader is in motion, the configuration of the positions 6a and/or the configuration of the positions 6b may provide information about the 2D spreading pattern.

Corresponding configurations of the predetermined positions 6 may be calculated, e.g. after entering the purpose of the measurement and/or the expected or intended spreading situation, e.g. in the on-board computer or a mobile device.

The calculated predetermined positions may be output, e.g. by the mobile device. They may be output, for example, as GPS data for the desired positions or by drawing the corresponding predetermined positions on a map of the field. Optionally, the output of the positions may help a user when laying out the collecting devices.

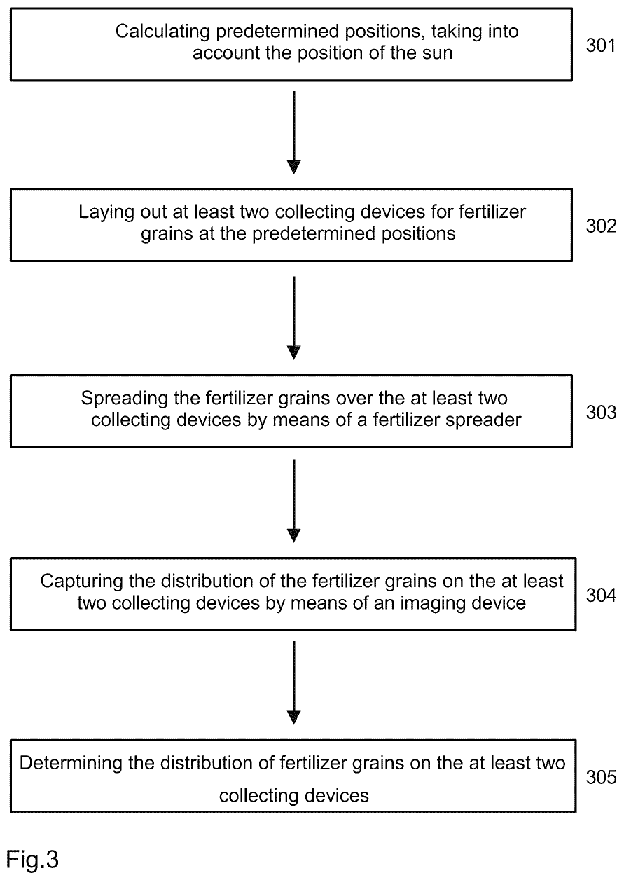

FIG. 3 shows an example flow chart of a method in which predetermined positions for at least two collecting devices for fertilizer grains are calculated, with the position of the sun being included as a parameter for calculating the predetermined positions.

The method comprises the step of calculating the predetermined positions, taking into account the position of the sun (step 301).

The position of the sun may be determined, for example, as described above. In particular, the predetermined positions may be calculated taking into account the position of the sun in such a way that collecting devices located at the predetermined positions (in particular after the fertilizer spreader has been driven over in a known direction) are not shaded by the machine, in particular the fertilizer spreader, and/or that the expected shadow cast by structures of the collecting device generates as little shadow cast on the collecting device as possible, i.e. trays are for example placed with the short side in the direction of the sunlight at the predetermined positions.

The exemplary method further comprises the steps of
laying out at least two collecting devices for fertilizer grains at the predetermined positions (step 302),
spreading the fertilizer grains over the at least two collecting devices by a fertilizer spreader (step 303), and
capturing the distribution of the fertilizer grains on the at least two collecting devices using an imaging device (step 304).

Because the predetermined positions have been calculated taking into account the position of the sun, the capturing by means of an imaging device may be carried out under the most uniform and consistent lighting conditions possible.

Furthermore, the method comprises the step of determining the distribution of fertilizer grains on the at least two collecting devices (step 305).

1. A method for determining a distribution of fertilizer grains comprising the steps of:
a) laying out at least two collecting devices for fertilizer grains at predetermined positions;
b) spreading the fertilizer grains over the at least two collecting devices using a fertilizer spreader;
c) capturing the distribution of the fertilizer grains on the at least two collecting devices using an imaging device;
d) determining the distribution of fertilizer grains on the at least two collecting devices.

2. The method according to claim 1, wherein the method further comprises:
interpolating the distribution of fertilizer grains for at least one region of the spreading pattern of the fertilizer spreader.

3. The method according to claim 1, wherein the predetermined positions are indicated, in particular determined, based on the expected spreading pattern.

4. The method according to claim 1, wherein the predetermined positions are arranged along only part of the expected spreading pattern.

5. The method according to claim 1, wherein at least one of the predetermined positions is arranged in a region of interest, in particular an expected edge or an expected maximum of the expected spreading pattern.

6. The method according to claim 1, wherein the predetermined positions are determined with respect to the fertilizer spreader.

7. The method according to claim 1, wherein the predetermined positions are calculated.

8. The method according to claim 1, wherein one or more of the following parameters are used to calculate the predetermined positions: GPS, position of the sun, degree of cloud cover; one or more inputs, fertilizer spreader parameters, type of fertilizer.

9. The method according to claim 1, wherein the predetermined positions are output, in particular on a screen of an on-board computer of the fertilizer spreader or of a mobile device.

10. The method according to claim 1, wherein a parameter of the spreading process is determined using the captured distribution of the fertilizer grains.

11. The method according to claim 10, wherein the one or more parameters of the spreading process comprise one or more of the following parameters: spreading width, spreading width distribution, spreading flank, spreading boundary, spreading direction, spreading height, spreading angle, switch points of the fertilizer spreader, deviation from the expected spreading pattern, deviation from the expected transverse distribution, 3D spreading pattern, 2D spreading pattern, spreading quantity, density of the fertilizer grains spread, grain size distribution.

12. The method according to claim 1, wherein one or more nominal settings for the fertilizer spreader are generated based on the determined parameters of the spreading process.

13. A system for determining a distribution of fertilizer grains, comprising at least two collecting devices for fertilizer grains, which may be laid out at different positions, and means for capturing the distribution of fertilizer grains on the at least two collecting devices.
